(19) United States
(12) Patent Application Publication
(10) Pub. No.: US 2007/0149390 A1
(43) Pub. Date: Jun. 28, 2007

(54) Catalysts for alkane or alkene oxidation and ammoxidation

(75) Inventors: Andre Harmen Sijpkes, Almere (NL); Roelandus Hendrikus Wilhelmus Moonen, Alkmaar (NL); Nelleke van der Puil, Amsterdam (NL); Sharifah Bee Abdul Hamid, Petaling Jaya (MY)

Correspondence Address: HOFFMANN & BARON, LLP, 6900 JERICHO TURNPIKE, SYOSSET, NY, 11791, US

(73) Assignees: AVANTIUM INTERNATIONAL B.V., AMSTERDAM (NL); UNIVERSITI MALAYA, KUALA LUMPUR (MY)

(21) Appl. No.: 10/583,010

(22) PCT Filed: Dec. 18, 2003
(86) PCT No.: PCT/NL03/00928

§ 371 Date: Jan. 24, 2007

(51) Int. Cl. B01J 27/057

(52) U.S. Cl. 502/215

(57) ABSTRACT

Described is a method for the preparation of Mo—V—Te—Nb catalyst comprising the steps of a) preparing a slurry comprising ionic species of Mo, V, Te and Nb and an inert carrier by combining the inert carrier in ceramic form with one or more solutions comprising the above metal ionic species; b) drying of the slurry to obtain a particulate product; c) precalcining the dried particulate product at a temperature of 150-350° C. in an oxygen-containing atmosphere; d) calcining the precalcined dried particulate product at a temperature of 350-750° C. in an inert atmosphere to obtain the catalyst. Further, a catalyst obtainable by the said method as well as uses thereof are described.

The present invention relates to a novel method for the preparation of a Mo—V—Te—Nb catalyst, a Mo—V—Te—Nb catalyst obtainable by the method and the use of such catalyst in the preparation of acrylic acid or acrylonitrile by catalytic oxidation or ammoxidation of propane, in the preparation of methacrylic acid or methacrylonitrile by catalytic oxidation or ammoxidation of isobutane, or in the preparation of acetic acid by catalytic oxidation of ethane.

(Meth)acrylic acid and (meth)acrylonitrile are industrially important compounds as starting materials for various polymers, detergents, fibers, rubbers and coating materials. The term “(meth)acrylic acid” as herein used refers to both acrylic acid and/or methacrylic acid. Similarly, the term “(meth)acrylonitrile” as used throughout the disclosure, refers to both acrylonitrile and/or methacrylonitrile.

The most common method known to produce (meth)acrylic acid or (meth)acrylonitrile is the catalytic reaction of an olefin such as propylene or isobutene with oxygen and optionally ammonia at a high temperature in a vapour phase in the presence of a catalyst.

However, in view of the considerable price difference between propane and propylene or between isobutane and isobutene, there is a growing interest in methods for the production of acetic acid, (meth)acrylic acid or (meth)acrylonitrile in one step from a lower alkane such as ethane, propane or isobutane, by subjecting the said alkane to a vapour phase catalytic oxidation (or ammoxidation) reaction in the presence of a catalyst. However, a commercially viable method for the preparation of acetic acid, acrylic acid, methacrylic acid, acrylonitrile or methacrylonitrile from ethane, propane or isobutane is yet to be achieved.

An impediment for obtaining a commercially viable method for the catalytic conversion of an alkane to an unsaturated carboxylic acid is the identification of a catalyst with sufficient conversion and selectivity. As such, in the art there is considerable interest in improved catalysts for the conversion of a lower alkane such as propane or isobutane to yield (meth)acrylic acid or (meth)acrylonitrile.

For example, oxide catalysts comprising molybdenum (Mo), vanadium (V), tellurium (Te) and niobium (Nb) are used for the catalytic oxidation or ammoxidation of propane or isobutane in the gaseous phase.

Such oxide catalysts are e.g. disclosed in EP 0 895 809. According to EP 0 895 809, a niobium-containing aqueous solution is mixed with an aqueous mixture or aqueous mixtures containing Mo, V and Te to form an aqueous compound mixture, which is then dried and calcined. Optionally, the aqueous compound mixture further comprises a silica sol such that the oxide catalyst is supported on a silica carrier.

However, the activity and selectivity of such catalysts was found to be insufficient for a viable industrial preparation of (meth)acrylic compounds. As such, in the art there remains a need for improved catalysts for the catalytic conversion of propane or isobutane to (meth)acrylic acid or (meth)acrylonitrile.

Surprisingly, it was found that improved catalytic activity and/or selectivity can be obtained when an inert carrier is provided in a ceramic form rather than in the form of a sol. The term “ceramic form” as used herein refers to a dry powder form.

Therefore, the present invention relates to a novel method for the preparation of Mo—V—Te—Nb catalyst comprising the steps of:
a) preparing a slurry comprising ionic species of Mo, V, Te and Nb and an inert carrier by combining the inert carrier in ceramic form with one or more solutions comprising the above metal ionic species and;
b) drying of the slurry to obtain a dried particulate product;
c) precalcining the dried particulate product at a temperature of 150-350° C. in an oxygen-containing atmosphere;
d) calcining the precalcined dried particulate product at a temperature of 350-750° C. in an inert atmosphere to obtain the catalyst.

As described above, “inert carrier in ceramic form” refers to an inert carrier, which is provided in ceramic form, i.e. in the form of a substantially dry powder, rather than in the form of a liquid sol. It was found that provision of the carrier in the form of a dry powder yielded a catalyst with improved activity in comparison to the catalyst obtained using a sol, in particular with regard to the oxidation process. The dry carrier powder may comprise up to 2 w/w % water.

The slurry is prepared from a ceramic inert carrier, which is combined with one or more solutions comprising Mo, V, Te and Nb ionic species. It is preferred that the ceramic inert carrier is combined with one solution comprising all the Mo, V, Te and Nb ionic species. This one solution may have been prepared from separate pre-solutions comprising the separate metals or combinations of two or more thereof, which are eventually combined as to form the one or more solutions. The ceramic carrier can be added to any one of the said solutions, or a combination thereof, in the preparation of the slurry. It is preferred that the slurry concentration, i.e. the amount of solids remaining after drying, is between 5 and 50 w/w % of the slurry, more preferably between 20 and 30 w/w %. Any Mo, V, Te and Nb ionic species providing compounds may be used to prepare the one or more solutions, e.g. soluble salts or acids such as e.g. molybdate salts, vanadate salts, telluric acid, and niobium salts, such as ammonium niobium oxalate. Any skilled practitioner will be capable of preparing such aqueous one or more solutions.

The ceramic inert carrier may be any ceramic inert carrier known in the art, such as e.g. alumina, silica gel, magnesia, silica-magnesia, calcia, zirconia, titania, zeolite, and silica-alumina. It is preferred that the ceramic inert carrier is silica, since it was found that the best catalysts were obtained using silica as the ceramic inert carrier.

It is preferred that the one or more solution/slurry comprises 850-950 mM Mo, 240-280 mM V, 175-230 mM Te and 75-130 mM Nb, with a final slurry concentration of 20-30 w/w %. However, in general, the specific solution concentrations for any given catalyst composition are determined by the atomic ratios of the metals, the (total) metal(s) loading on the catalyst, and the slurry concentration. A skilled practitioner will readily be able to establish suitable concentrations.

The pH of the slurry is preferably at most 5, more preferably at most 4, and most preferably in the range of 2-4, as it was found that effective catalysts were thus obtained.

In step b), the slurry of the ceramic inert carrier and the aqueous solution comprising ions of Mo, V, Te and Nb obtained in step a) is subjected to drying to obtain a dried particulate product. The drying can be performed by any method known in the art, such as rota-evaporation or spray-drying. It is preferred that said drying is performed by spray-drying, as this is a well-known method in the art for drying of mixtures or slurries, especially in an industrial setting. As such, someone with ordinary skill in the art will readily be able to determine a suitable procedure and corresponding parameters, such as temperature and pressure, for drying of a slurry as prepared in step a). The particulate product thus obtained is a free flowing powder that typically has a particle size of 1-100 μm.

The drying is preferably performed while maintaining a high degree of mixing between the metal precursor phases. This can for example be achieved by rotary evaporation, by drying while agitating, by freeze-drying, or by spray-drying.

In step c) the dried particulate product is precalcined at a temperature of 150-350° C. in an oxygen-containing atmosphere. The oxygen-containing atmosphere may e.g. take place in an atmosphere of air or under a stream of air. It is preferred that the precalcination is performed at a temperature of 250-350° C., preferably for 1-5 hours, most preferably for about 1 hour. During this precalcination treatment, the dried particulate product is further dried, while it is also assumed that the intermixed metal species precursors are partly decomposed. Furthermore, it is assumed that the metal species are fixed into relative positions in the catalyst matrix during the precalcination step.

In step d), the precalcined dried particulate product is calcined at a temperature of 350-750° C. in an inert atmosphere to obtain the catalyst. It is preferred that the calcination is conducted at a temperature of 450-700° C., more preferably of 550-650° C., preferably for 0.5-24 hrs, more preferably for 1-8 hrs. The precalcination and calcination step may be carried out consecutively by alteration of the atmosphere in the (pre)calcination vessel. The inert atmosphere may be any inert atmosphere which is substantially free of oxygen, preferably under a stream of an inert gas, such as e.g. a nitrogen atmosphere, argon atmosphere or helium atmosphere.

It was found that the catalysts prepared by the method according to the invention showed excellent results in oxidation tests, as will be illustrated below in Table 1. It is currently hypothesised that catalysts that are prepared using ceramic carrier powder have a particle density that is significantly higher than the catalysts that result from the use of sol. The catalyst activity per catalyst volume after shaping will therefore be higher for the catalysts prepared from ceramic carrier powder.

The spray-drying can be performed by any method known in the art, e.g. centrifugation, two-phase flow nozzle method or high pressure nozzle method to obtain a dried particulate. It is preferred to use air which has been heated e.g. by an electric heater or steam, as a heat source for drying. Alternatively, spray-drying may be performed by spraying the slurry onto a steel plate which has been heated.

In an attractive embodiment, the spray-drying is performed at a temperature of 100-250° C. In case a spray-drying tower is used, it is preferred that the temperature of the spray-dryer at an entrance to the dryer section thereof is from 150-250° C. Improved activity and/or selectivity is thus obtained.

In a further embodiment, the calcining is conducted in an argon or nitrogen atmosphere, as it was found that thus the best performing catalysts were obtained.

It is preferred that the ceramic inert carrier according to the present invention has a mean particle size of 0.1-100, preferably 1-50, most preferably 3-20 nm, before being added to the one or more solutions to prepare the slurry.

In another embodiment, the method according to the present invention comprises an additional step e) of processing the catalyst of step d) to catalyst particles having a size of 0.1-5 mm. Catalyst particles with such mean particle size have been found to perform especially well in fixed bed reactors. Said processing can be performed by any means known in the art, such as e.g. shaping, crushing, extruding, sieving, or any combination thereof.

In a second aspect, the present invention relates to a Mo—V—Te—Nb catalyst obtainable by any of the methods according to the present invention. It was found that such catalyst performed better with regard to activity and selectivity than catalysts according to the prior art.

In a further aspect, the present invention relates to the use of a catalyst according to the present invention for the preparation of acrylic acid or acrylonitrile by catalytic oxidation or ammoxidation, respectively, of propane.

In yet a further aspect, the present invention relates to the use of a catalyst according to the present invention for the preparation of methacrylic acid or methacrylonitrile by catalytic oxidation or ammoxidation, respectively, of isobutane.

In again a further aspect, the present invention relates to the use of a catalyst according to the present invention for the preparation of acetic acid by catalytic oxidation of ethane.

(Meth)acrylic acid, (meth)acrylonitrile and acetic acid can be produced in any conventional manner, such as e.g. by the gaseous phase oxidation or the gaseous phase ammoxidation of ethane, propane or isobutane in the presence of the catalyst according to the present invention.

The preparation of (meth)acrylic acid, (meth)acrylonitrile or acetic acid can be conducted in any conventional reactor, such as e.g. a fixed bed reactor, a fluidised bed reactor or a moving-bed reactor. It is not required that the ethane, propane or isobutane and optionally ammonia used in the present invention are of high purity, and they may be of a commercial grade.

Non-limiting examples of oxygen sources for the oxidation of ethane, propane or isobutane include air, oxygen-rich air and pure oxygen. Also, such oxygen source may optionally be diluted with helium, argon, nitrogen, carbon dioxide, steam.

Generally, the catalytic ammoxidation of propane or isobutane is conducted in the presence of ammonia in addition to the oxygen source.

It is preferred that the oxidation or ammoxidation is conducted in a fixed bed reactor, as the catalyst according to the present invention performs particularly well in such reactor.

Hereafter, the present invention will be described in more detail with reference to the following examples, which are merely meant to illustrate the present invention, and not to limit its scope in any way.

### EXAMPLE 1

Mo₁V_{3.0}Te_{0.23}Nb_{0.12} on ceramic silica support

A first solution A was prepared by dissolving 78.9 g ammonium heptamolybdate tetrahydrate (Aldrich), 15.7 g ammonium metavanadate (Aldrich), and 23.6 g telluric acid (Aldrich) in 700 mL water. A second solution B was prepared by dissolving 24.7 g ammonium niobium oxalate (Starck HC) and 8.6 g oxalic acid dihydrate (Aldrich) in 200 g water. Solution B was added to solution A. Next, 100 g silica powder (Aerosil 300, Degussa) was added. The resulting slurry (23% wt solids concentration) was spraydried. The resulting powder was dried at 325° C. for 1 h in air and subsequently at 650° C. for 2 h under a flow of argon. The final catalyst comprised 33.9% wt Mo—V—Te—Nb (metals) on silica (50% wt Mo—V—Te—Nb metal oxides).

### EXAMPLE 2

Mo₁V_{0.3}Te_{0.23}Nb_{0.12} on ceramic silica support

The catalyst precursor solutions A and B were prepared according to the procedure described in example 1. Solution B was added to solution A. Next, 100 g silica powder (Aerosil 300, Degussa) was added. The resulting slurry (23% wt solids concentration) was dried by rotary evaporation. The resulting powder was dried at 325° C. for 1 h in air and subsequently at 650° C. for 2 h under a flow of argon. The final catalyst is 33.9% wt Mo—V—Te—Nb (metals) on silica (50% wt Mo—V—Te—Nb metal oxides).

### COMPARATIVE EXAMPLE 1

A first solution A was prepared by dissolving 12.09 g ammonium heptamolybdate tetrahydrate (Aldrich) in 100 g water while heating to 70° C. After dissolution of the molybdate, 2.40 g ammonium metavanadate (Aldrich), and 3.62 g telluric acid (Aldrich) were dissolved. After all the salts had dissolved the solution was cooled to <40° C. A second solution B was prepared by dissolving 65.0 g ammonium niobium oxalate (Starck HC) and 22.7 g oxalic acid dihydrate (Aldrich) in 935 g water. To solution A was added 59.4 g of solution B. Next, 5.2 g silica sol (Ludox, 40% wt colloidal silica, Aldrich) was added. The mixture was dried on a rota-evaporator (<50 mbar pressure, 50° C., 150 rpm, 3 h). The product was dried at 275° C. for 1 h in air and subsequently at 600° C. for 2 h under a flow of argon. The final catalyst comprised 33.9% wt Mo—V—Te—Nb (metals) on silica (50% wt Mo—V—Te—Nb metal oxides).

### COMPARATIVE EXAMPLE 2

(Mo₁V_{0.3}Te_{0.23}Nb_{0.12})

A first solution A was prepared by dissolving 157.7 g ammonium heptamolybdate tetrahydrate (Aldrich), 31.4 g ammonium metavanadate (Aldrich), and 47.2 g telluric acid (Aldrich) in 700 mL water. A second solution B was prepared by dissolving 49.3 g ammonium niobium oxalate (Starck HC) and 17.2 g oxalic acid dihydrate (Aldrich) in 200 g water. Solution B was added to solution A. The resulting slurry (24 % wt solids concentration) was spraydried. The resulting powder was dried at 325° C. for 1 h in air and subsequently at 650° C. for 2 h under a flow of argon. The final catalyst is 67.8% wt Mo—V—Te—Nb (metals) (100% wt Mo—V—Te—Nb metal oxides).

### COMPARATIVE EXAMPLE 3

M₁V_{0.3}Te_{0.23}Nb_{0.12} Mixed Metal Oxide

A first solution A was prepared by dissolving 24.18 g ammonium heptamolybdate tetrahydrate (Aldrich) in 200 g water while heating to 70° C. After dissolution of the molybdate, 4.80 g ammonium metavanadate (Aldrich), and 7.24 g telluric acid (Aldrich) were dissolved. After all the salts had dissolved the solution was cooled to <40° C. A second solution B was prepared by dissolving 65.0 g ammonium niobium oxalate (Starck HC) and 22.7 g oxalic acid dihydrate (Aldrich) in 935 g water. To solution A was added 118.8 g of solution B. The mixture was dried at a rota-evaporator. The product, orange crystals, was dried at 325° C. for 1 h in air and subsequently at 650° C. for 2 h under a flow of argon.

### EXAMPLE 5

Catalyst Testing

100 mg of catalyst was tested in a fixed bed reactor at a space velocity of 1200 h⁻¹ at 350-410° C. The feed gas composition was 3.3 vol % propane, 10 vol % 02, 40 vol % N₂ and 46.6 vol % H₂O. All catalysts were stabilized at 400° C. for 24 hours in the feed gas before the activity measurements. The catalyst performance is summarised in Table 1 below.

TABLE 1
Catalyst test results (Mo₁V_{0.3}Te_{0.23}Nb_{0.12} catalyst compositions). Observed at 410° C. in the oxidation
of propane to acrylic acid.

| | | | | Conv. | Selectivity | Yield | Pore structure | | |
|---|---|---|---|---|---|---|---|---|---|
| | Drying | | % wt | C₃ | AA | AA | PV | SA | APD |
| Catalyst | method | Support | metals | (%) | (%) | (%) | (mL/g) | (m²/g) | (g/mL) |
| Ex. 1 | SD | Aerosil 300 | 33.9 | 40 | 75 | 30 | 0.28 | 50 | 1.8 |
| Ex. 2 | RV | Aerosil 300 | 33.9 | 38 | 77 | 29 | 0.37 | 45 | 1.5 |
| Comp. Ex. 1 | RV | Ludox | 33.9 | n.d. | n.d. | n.d. | 1.26 | 202 | 0.6 |
| Comp. Ex. 2 | SD | none | 67.8 | 30 | 64 | 19 | 0.02 | 5.9 | 4.5 |
| Comp. Ex. 3 | RV | none | 67.8 | 55 | 45 | 25 | 0.02 | 6.3 | 4.5 |

SD = spraydrying; RV = rota-evaporation
C₃ Conv. = conversion of propane (percentage)
AA Selectivity = selectivity of propane conversion to acrylic acid (in percent)
AA Yield = the yield of acrylic acid (in percent)
PV = pore volume
SA = surface area
APD = Apparent Particle Density, defined as (1/SKD + PV)⁻¹, where SKD is the Skeletal Density. The SKD is the sum of the component densities (Σᵢ Xᵢd_{i,} with Xᵢ the weight fraction and dᵢ the density of the i-th component).

1. Method for the preparation of Mo—V—Te—Nb catalyst comprising the steps of:
a) preparing a slurry comprising ionic species of Mo, V, Te and Nb and an inert carrier by combining the inert carrier in the form of a powder with one or more solutions comprising the above metal ionic species;
b) drying of the slurry to obtain a particulate product;
c) precalcining the dried particulate product at a temperature of 150-350° C. in an oxygen-containing atmosphere;
d) calcining the precalcined dried particulate product at a temperature of 350-750° C. in an inert atmosphere to obtain the catalyst.

2. Method according to claim 1 wherein the drying is performed by spray-drying, the spray-drying preferably being performed at a temperature of 100-250° C.

3. Method according to claim 1, wherein the calcining is conducted in an argon or nitrogen atmosphere.

4. Method according to claim 1, wherein the ceramic inert carrier has a mean particle size of 0.1-100 nm.

5. Method according to claim 1, comprising an additional step e) of processing the catalyst of step d) to catalyst particles having a size of 0.1-5 mm.

6. Mo—V—Te—Nb catalyst obtainable by the method of claim 1.

7. Use of a catalyst according to claim 6 for the preparation of acrylic acid or acrylonitrile by catalytic oxidation or ammoxidation, respectively, of propane.

8. Use of a catalyst according to claim 6 for the preparation of methacrylic acid or methacrylonitrile by catalytic oxidation or ammoxidation, respectively, of isobutane.

9. Use of a catalyst according to claim 6 for the preparation of acetic acid by catalytic oxidation of ethane.

10. Use according to claim 7, wherein the oxidation or ammoxidation is conducted in a fixed bed reactor.

11. Use according to claim 8, wherein the oxidation or ammoxidation is conducted in a fixed bed reactor.

12. Use according to claim 9, wherein the oxidation or ammoxidation is conducted in a fixed bed reactor.
